(19) United States
(12) Patent Application Publication
(10) Pub. No.: US 2017/0333929 A1
(43) Pub. Date: Nov. 23, 2017

(54) PORTABLE ELECTRONIC DEVICE CASING FOR STORING AND DISPENSING CHEMICAL PRODUCTS

(71) Applicant: ANTON DZURILLA, HNILCIK (SK)

(72) Inventor: ANTON DZURILLA, HNILCIK (SK)

(21) Appl. No.: 15/598,788

(22) Filed: May 18, 2017

Related U.S. Application Data
(60) Provisional application No. 62/338,256, filed on May 18, 2016.

(51) Int. Cl. B05B 9/04; A45C 11/00; A45C 13/00; A45F 5/00; H04W 88/02

(52) U.S. Cl. CPC B05B 9/04; A45C 13/002; A45F 5/00; A45C 11/00; A45C 2011/001; A45C 2011/003; H04W 88/02; A45C 2011/002

(57) ABSTRACT

Disclosed is a portable electronic device casing for storing and dispensing chemical products. The portable electronic device casing includes housing, an output port and plurality of release buttons. The housing includes a front side portion to receive a portable electronic device and a rear side portion extending from the front side portion. The rear side portion having plurality of storage chambers to store chemical products. The output port is configured in the housing to release the stored chemical product from at least one of the plurality of storage chambers. Each of the release buttons is configured with each of the plurality of storage chambers. The release button releases the chemical product from the respective storage chamber through the output port. Further, the portable electronic device casing includes chemical product capsules for storing chemical products are inserted in the storage chambers. Furthermore, the portable electronic device casing includes plurality of releasing ports to dispense the chemical product from either the chemical product capsules or the storage chamber.

### CROSS REFERENCE TO RELATED APPLICATION

This application claims priority of U.S. application No. 62/338,256 filed on May 18, 2016 which is incorporated by reference herein in its entirety.

### BACKGROUND OF THE INVENTION

### 1. Field of the Invention

The present invention generally relates to a mobile electronic device cover, and more particularly relates to a portable electronic device casing for storing and dispensing chemical products.

### 2. Description of Related Art

With fast development of modern technology, many advanced and sophisticated mobile electronic products such as smart phones, tablet computers, mobile multimedia players, and etc. have been continuously created and have appeared on the market. These advanced and sophisticated mobile electronic products are still expensive.

To protect a mobile electronic device against scratches and to prolong its lifespan, a protective cover or film may be used. Various protective covers are commercially available. However, these protective covers are simply designed to protect a particular mobile electronic device without any added function.

Aroma emitting devices are well known and are commonly used in homes and commercial establishments to provide a pleasant atmosphere for people in given areas. Such devices passively or actively transmit aromas to the general surroundings. Further, people may spray serum on the hair or perfume on the clothes or carry an essential oil or insect repellent when going out.

However, it is a burden or inconvenience to carry an essential oil, perfume or insect repellent when one is going out for dinner or other purposes. Therefore, there is a need of a portable electronic device that stores and dispenses chemicals when required by the user. The portable electronic device covering is able to store products like perfume, insect repellant, hair spray serums etc.

### SUMMARY OF THE INVENTION

In accordance with teachings of the present invention, a portable electronic device casing for storing and dispensing chemical products is provided.

An object of the present invention is to provide a portable electronic device casing for storing and dispensing chemical products. The portable electronic device casing includes housing, an output port and plurality of release buttons.

The housing includes a front side portion to receive a portable electronic device and a rear side portion extending from the front side portion. The rear side portion having plurality of storage chambers to store chemical products. The output port is configured in the housing to release the stored chemical product from at least one of the plurality of storage chambers.

Each of the release buttons is configured with each of the plurality of storage chambers. The release button releases the chemical product from the respective storage chamber through the output port.

Another object of the present invention is to provide the portable electronic device casing with plurality of chemical product capsules.

Each of the chemical product capsules is configured to insert inside each of the plurality of storage chambers. The release button is pressed to release the chemical product stored in the chemical product capsule through the output port.

Another object of the present invention is to provide the portable electronic device casing wherein each of the plurality of storage chambers and each of the plurality of chemical product capsules store different types of chemical products.

Another object of the present invention is to provide the portable electronic device casing further includes plurality of releasing ports, wherein each of the releasing port configured to attach with each of the plurality of storage chambers, wherein the releasing port releases the chemical product from the respective storage chamber.

Another object of the present invention is to provide the portable electronic device casing with plurality of open slots. Each open slot is configured to allow inserting of the chemical products in each storage chamber. Further, the open slots configured to allow filling of the chemical product capsule with the chemical products.

Another object of the present invention is to provide the portable electronic device casing with plurality of recharge capsules. Each of the recharge capsules recharges each of the chemical product capsules with the chemical product through the open slots.

Another object of the present invention is to provide the portable electronic device casing the recharge capsule further recharges the storage chambers with the chemical product through the open slots. The recharge capsule stores 10 ml of the chemical product.

These and other features and advantages will become apparent from the following detailed description of illustrative embodiments thereof, which is to be read in connection with the accompanying drawings.

### BRIEF DESCRIPTION OF DRAWINGS

FIG. 1 illustrates a rear view of a portable electronic device casing in accordance with a preferred embodiment of the present invention;

FIG. 2 illustrates a side view of the portable electronic device casing in accordance with another preferred embodiment of the present invention;

FIG. 3 illustrates a perspective view of the portable electronic device casing in accordance with another preferred embodiment of the present invention;

FIG. 4 illustrates an inside view of rear portion of housing to display plurality of chemical product capsules in accordance with another preferred embodiment of the present invention; and

FIG. 5 illustrates a partial perspective view of the portable electronic device casing in accordance with another preferred embodiment of the present invention.

### DETAILED DESCRIPTION OF DRAWINGS

The following detailed description is directed to certain specific embodiments of the invention. However, the invention can be embodied in a multitude of different ways as defined and covered by the claims and their equivalents. In this description, reference is made to the drawings wherein like parts are designated with like numerals throughout. Unless otherwise noted in this specification or in the claims, all of the terms used in the specification and the claims will have the meanings normally ascribed to these terms by workers in the art.

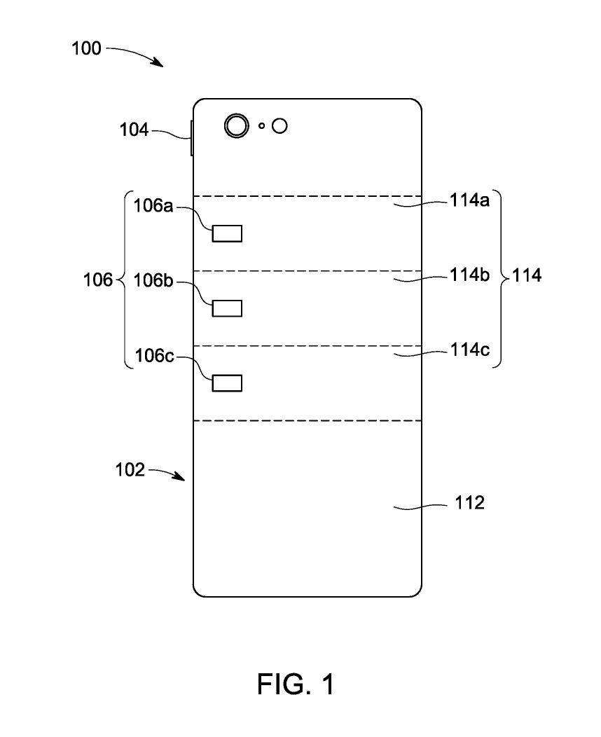

FIG. 1 illustrates a rear view of a portable electronic device casing 100 for dispensing stored chemical products on action caused by a user in accordance with a preferred embodiment of the present invention. The portable electronic device casing 100 includes a housing 102, an output port 104, and plurality of release buttons 106 such as 106a, 106b and 106c.

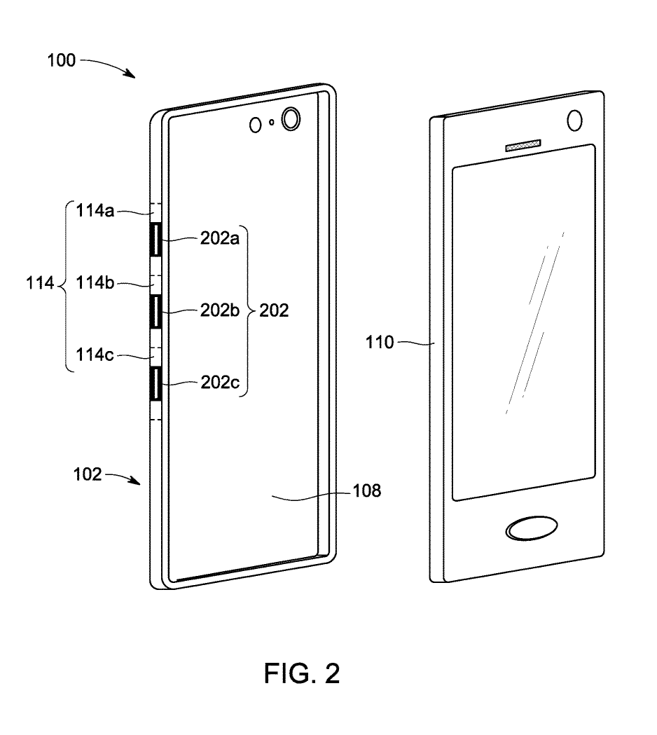

The housing 102 is having a front side portion (108, shown in FIG. 2) to receive a portable electronic device (110, shown in FIG. 2) and a rear side portion 112 extending from the front side portion (108, shown in FIG. 2). The front side portion (108, shown in FIG. 2) and the portable electronic device (110, shown in FIG. 2) is shown and explained in detail in conjunction with FIG. 2 of the present invention.

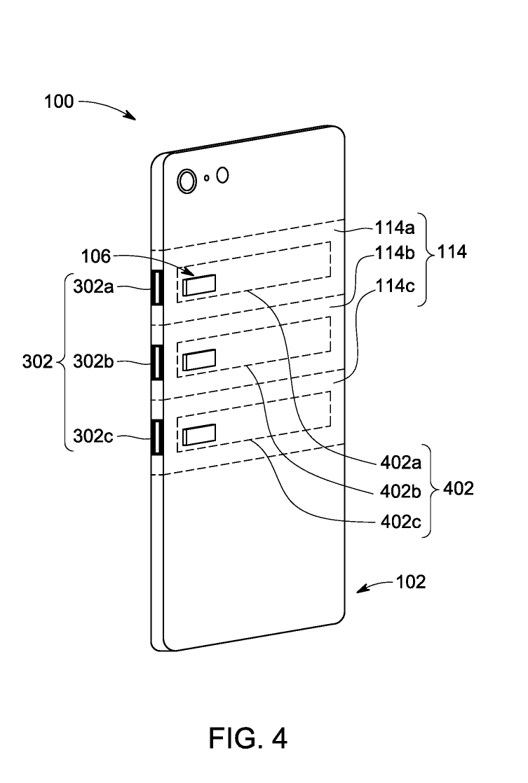

The rear side portion 112 is having plurality of storage chambers 114 such as 114a, 114b and 114c to store chemical products. The storage chambers 114 are hollow and stores chemical products inside. The chemical product is shown and explained in detail in conjunction with FIG. 4 of the present invention.

The storage chambers 114 are configured across the width of the housing 102. Generally, the storage chambers 114 are rectangular in shape. However, it would be readily apparent to those skilled in the art that various shapes of storage chambers 114 may be envisioned without deviating from the scope of the present invention.

Each of the release buttons 106 is configured to associate with each of the plurality of storage chambers 114. The release buttons 106 releases the chemical product from the respective storage chamber. The user presses one of the release buttons 106 to release the chemical product stored in the respective associated storage chambers 114.

For exemplary purposes as shown in FIG. 1, the release button 106a is associated with the storage chamber 114a, the release button 106b is associated with the storage chamber 114b and the release chamber 106c is associated with the storage chamber 114c.

The output port 104 is configured in the housing 102 to release the stored chemical product from at least one of the plurality of storage chambers 114 when the user presses one of the plurality of release buttons 106. For exemplary purposes, the user presses the release button 106a and the output port 104 dispenses the chemical product stored in the storage chamber 114a.

In another preferred embodiment of the present invention, the output port 104 is connected to each of the storage chambers 114 through a conduit (not shown in figures). The conduit is taking the chemical product stored in the plurality of storage chambers 114 to the output port 104 when the user presses the corresponding associated one of the release buttons 106.

FIG. 2 illustrates a side view of the portable electronic device casing 100 in accordance with another preferred embodiment of the present invention. The portable electronic device casing 100 further includes plurality of open slots 202 such as open slot 202a, open slot 202b and open slot 202c.

The open slot 202a is configured to allow inserting of the chemical products in the storage chamber 114a. Similarly, the open slot 202b and the open slot 202c are configured to allow inserting of the chemical products in the storage chamber 114b and the storage chamber 114c, respectively.

With reference to FIG. 1, the portable electronic device casing 100 includes the front side portion 108 to receive the portable electronic device 110. Example of the portable electronic device 110 includes but not limited to smartphones, Ipad, mobile phones, tablet etc.

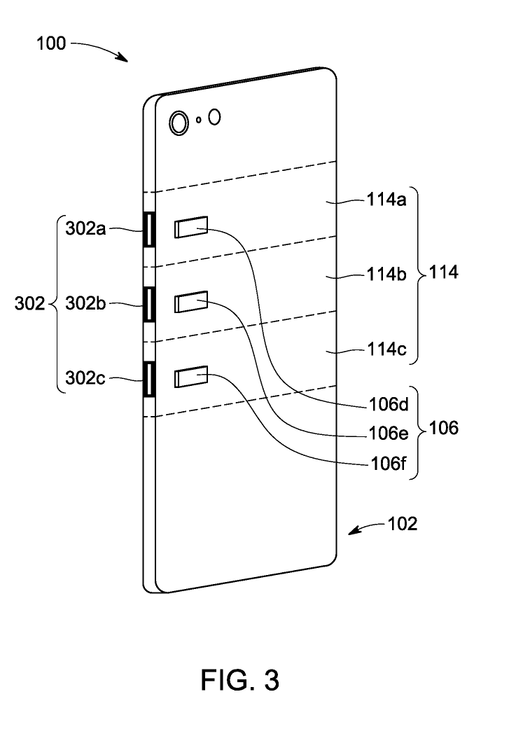

FIG. 3 illustrates a perspective view of the portable electronic device casing 100 in accordance with another preferred embodiment of the present invention. The portable electronic device casing 100 further includes plurality of releasing ports 302 such as 302a, 302b and 302c for dispensing the chemical product from the corresponding storage chambers 114 when the user presses the corresponding release button 106.

Each of the releasing ports 302 are configured to attach with each of plurality of storage chambers 114. For exemplary purposes, the release port 302a dispenses the chemical product from the storage chamber 114a when the user presses the release button 106d. Similarly, the release port 302b and the release port 302c dispense the chemical product from the storage chamber 114b and the storage chamber 114c respectively, when the user presses the release button 106e and the release button 106f respectively.

FIG. 4 illustrates an inside view of rear portion of housing 102 in accordance with another preferred embodiment of the present invention. The portable electronic device casing 100 further includes plurality of chemical product capsules 402 such as chemical product capsule 402a, chemical product capsule 402b, and chemical product capsule 402c for storing chemical product.

The chemical product capsule 402a is inserted in the storage chamber 114a to release the stored chemical product when the user presses the release button (106 shown in FIG. 1 and FIG. 3). Similarly, the chemical product capsule 402b and the chemical product capsule 402c are inserted in the storage chamber 114b and the storage chamber 114c respectively.

In another preferred embodiment of the present invention, the chemical product is inserted in the chemical product capsule 402 through the open slots (202, shown in FIG. 2). Example of chemical products includes but not limited to serum, perfumes, insect repellant etc.

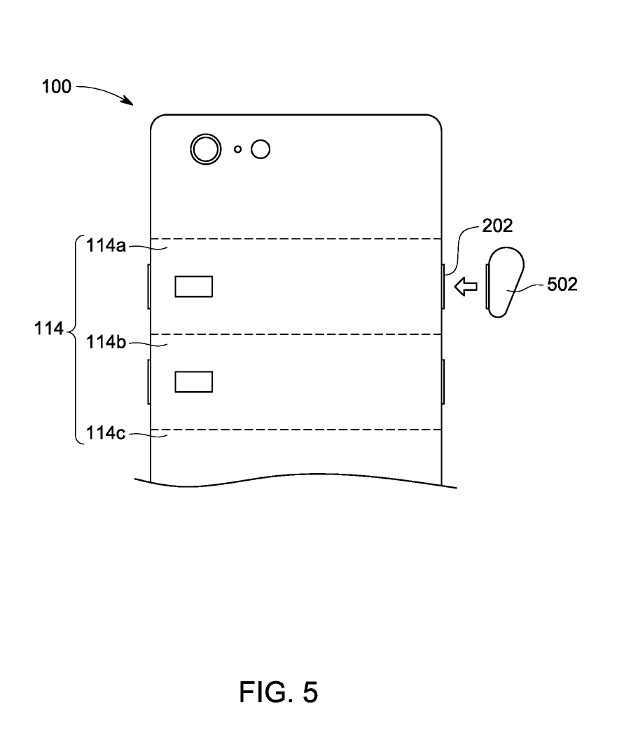

FIG. 5 illustrates a partial perspective view of the portable electronic device casing 100 in accordance with another preferred embodiment of the present invention. The portable electronic device casing 100 further includes plurality of recharge capsules 502 for recharging the storage chambers 114 with the chemical product through the open slots 202.

As shown in FIG. 5, the recharge capsule 502 is used to recharge the storage chamber 114a with the chemical product. Similarly, various other recharge capsules 502 may be used to recharge either the storage chambers 114 or the chemical product capsule (402, shown in FIG. 4).

The recharge capsules 502 are configured to attach with the open slots 202. The user presses the recharge capsule 502 to transfer the chemical product either into the storage chambers 114 or the chemical product capsule (402, shown in FIG. 4). In a preferred embodiment of the present invention, the recharge capsule 502 stores 10 ml of the chemical product.

The present invention offers various advantages such as providing a portable casing to carry phone and many chemical products together. The chemical products like serum, perfume, deodorant etc are required by users time to time. The present invention avoids carrying of bulky containers of such chemical product always and thus providing a small volume to be carried with the mobile casing and to be used at the convenience.

These and other changes can be made to the invention in light of the above detailed description. In general, the terms used in the following claims, should not be construed to limit the invention to the specific embodiments disclosed in the specification, unless the above detailed description explicitly defines such terms. Accordingly, the actual scope of the invention encompasses the disclosed embodiments and all equivalent ways of practicing or implementing the invention under the claims.

1. A portable electronic device casing for dispensing stored chemical products on action caused by a user, the portable electronic device casing comprising:
a housing having a front side portion to receive a portable electronic device, and a rear side portion extending from the front side portion, the rear side portion having plurality of storage chambers to store chemical products;
plurality of release buttons, wherein each of the release button configured to associated with each of the plurality of storage chambers, wherein the release button releases the chemical product from the respective associated storage chamber; and
an output port configured in the housing to dispense the stored chemical product from one of the plurality of storage chambers when the user presses one of the plurality of release buttons.

2. The portable electronic device casing according to claim 1 further comprising plurality of chemical product capsules, wherein each of the chemical product capsule configured to insert inside each of the plurality of storage chambers, wherein the release button is pressed to release the chemical product stored in the chemical product capsule through the output port.

3. The portable electronic device casing according to claim 1 wherein each of the plurality of storage chambers and each of the plurality of chemical product capsules store different types of chemical products.

4. The portable electronic device casing according to claim 1 further comprising plurality of releasing ports, wherein each of the releasing ports configured to attach with each of the plurality of storage chambers, wherein one of the releasing ports dispenses the chemical product from the corresponding storage chamber when the user presses the corresponding release button.

5. The portable electronic device casing according to claim 2 further comprising plurality of open slots, wherein each open slot configured to allow inserting of the chemical products in each storage chamber.

6. The portable electronic device casing according to claim 5 wherein the open slots further configured to allow filling of the chemical product capsule with the chemical products.

7. The portable electronic device casing according to claim 6 further comprising plurality of recharge capsules, wherein the recharge capsule recharges the chemical product capsules with the chemical product through the open slots.

8. The portable electronic device casing according to claim 7 wherein the recharge capsule further recharges the storage chambers with the chemical product through the open slots.

9. The portable electronic device casing according to claim 8 wherein the recharge capsules stores 10 ml of the chemical product.
